(19) United States
(12) Patent Application Publication
(10) Pub. No.: US 2023/0264281 A1
(43) Pub. Date: Aug. 24, 2023

(54) METHOD FOR MACHINING TOOTHING SYSTEMS

(71) Applicant: GLEASON-PFAUTER MASCHINENFABRIK GMBH, Ludwigsburg (DE)

(72) Inventor: Ralf Schmezer, Ludwigsburg (DE)

(21) Appl. No.: 18/005,230

(22) PCT Filed: Jul. 20, 2021
(86) PCT No.: PCT/EP2021/070216

§ 371 Date: Jan. 12, 2023

(30) Foreign Application Priority Data
Jul. 20, 2020 (DE) 10 2020 004 346.1

(51) Int. Cl. B23F 5/20

(52) U.S. Cl. CPC B23F 5/202

(57) ABSTRACT

The invention relates to a method for machining toothing systems, in which, for a series of workpieces with an identical target geometry, a toothing system is produced or machined on a respective workpiece in a first machining operation and, in a second machining operation, with a machining tool, additional tooth shaping of the toothing system resulting from the first machining - in particular, chamfering of a tooth end edge of this toothing system - is carried out in a relative positioning with respect thereto, wherein a controller of the second machining operation automatically detects, at least in part, a change in a workpiece property, which is in particular independent of the first machining operation, and/or in a setting of the first machining operation - in particular, with respect to a respectively predetermined reference - and carries out the relative positioning as a function of the detected change.

The invention relates to a method for machining toothing systems, in which, for a series of workpieces with an identical target geometry, a toothing system is produced or machined on a respective workpiece in a first machining operation and, in a second machining operation, with a machining tool, additional tooth shaping of the toothing system resulting from the first machining – in particular, chamfering of a tooth end edge of this toothing system – is carried out in a relative positioning with respect thereto.

Such methods are of course well known in the prior art, e.g., by large-scale production of gear wheels by means of hobbing, for example, with subsequent chamfering with a selected chamfering technique, which can, for example, be a chamfering hobbing as disclosed in WO 2019/161942 A1, or other – in particular, cutting – chamfering methods, such as a chamfer cut (EP 1495 824 B1), skiving chamfering (WO 2015/014448A1), or others.

Usually, the machine controllers and operator interfaces of modern toothing machines are already technically mature, such that, with regard to the desired chamfer, the operator enters the parameters characterizing the chamfer, such as chamfer width and/or chamfer angle, into the controller, and the machine controller independently calculates the machine axis settings, required for chamfering, for the second machining operation.

The processing of a workpiece batch of larger numbers of pieces is usually carried out only when the toothing system of the first machining operation is initially within desired tolerance limits with respect to the target toothing. In addition, the toothing systems are usually measured at regular intervals in order to monitor the maintenance of the tolerances. If it is found that a measurement value describing the chamfer shape moves towards a tolerance limit, e.g., the chamfer width becomes too small, the operator can take corrective action and enter a chamfer width that is higher by the difference from the target chamfer width, instead of the actual target width, so that the process that is then controlled to the “virtually too large chamfer width” produces the actually desired chamfer as a countermeasure. To some extent, modern machine controllers are already technically mature, such that only one measured value from the measured chamfer has to be input into the machine controller, which then independently calculates the deviation from a predetermined target value and carries out the corrections required for adjustment.

However, in spite of all these monitoring and corrective measures, larger workpiece batches always include workpieces that do not correspond to the desired expectations with regard to the additional tooth shaping carried out and have left the predetermined tolerance zone - in particular, in the case of narrowly set tolerance zones.

The invention is therefore based upon the object of improving a method of the type mentioned at the beginning in the direction of a reduction in the relative deviation of individual results of the individual tooth formations of workpieces of the workpiece batch from one another.

This object is achieved by the invention by a development of the method of the type mentioned at the beginning, said development being essentially characterized in that a controller of the second machining operation automatically detects, at least in part, a change in a workpiece property, which is in particular independent of the first machining operation, and/or in a setting of the first machining operation – in particular, with respect to a respectively predetermined reference – and carries out the relative positioning as a function of the detected change.

It has thus been recognized according to the invention that setting changes of the first machining operation set by the operator or automatically adjusted as a result of changed factors of the first machining operation can, for example, influence the position of the tooth edges of the toothing system, and that a greater deviation from the desired target chamfer geometry can result due to the changed position. By means of the at least partially automatic detection of the change according to the invention, these effects can be predicted and counteracted. The additional tooth shaping – in particular, the chamfering - thus becomes adaptive chamfering with regard to changed factors of the first machining operation. The invention can also take into account a factor of the machining preceding the first machining operation, viz., for example, the production of the workpiece blanks, which is reflected in a change in the workpiece property. By way of example, as explained in detail later, deviations can arise when the workpiece blanks are turned out, leading to a changed clamping height in the additional tooth shaping.

The second machining thus takes place as an at least partially automatic, adaptive, additional tooth shaping in response to the pre-machining changing of the tooth edge position. As a reference, the respective setting for the previous workpiece can be used, or absolute values of the changed values can be compared with predetermined absolute references, or a mixed form of both variants.

In a preferred method embodiment, the first machining operation is a soft machining operation - in particular, hobbing, skiving, or generating shaping. A particularly preferred type of first machining operation is hobbing, but, if necessary, due to interfering contours which impede or prevent hobbing, skiving is then primarily preferred, but generating shaping may also be used.

In a further preferred method embodiment, the second machining operation is a cutting chamfering, and the target geometry has in this respect a predetermined chamfer shape and chamfer size. Compared to the rolling pressure deburring which is still widely used, cutting chamfering has the advantage of avoiding/reducing so-called secondary burrs.

In a further preferred method embodiment, the second machining is carried out in a rolling method - in particular, in the intervention kinematics of hobbing. In this respect, one-flank interventions are preferred; for preferred intervention kinematics, reference is made to the kinematics disclosed in WO 2019/161942 A1. However, other cutting methods are also considered, e.g., a skiving method disclosed in WO 2015/014448 A1, and also the so-called “chamfer cut” method, which is described in EP 1 495 824 B1.

In a further preferred method embodiment, the detected change includes a modification of the flank line of the toothing system. In particular, detected changes in the form of a flank line angle correction of the first machining operation are advised, since the latter are related to inclination angle changes and axial distance changes, e.g., in the case of hobbing as the machining type of the first machining operation.

In a further preferred method embodiment, the detected change includes a modification of the tooth thickness of the toothing system. A tooth thickness modification is also related to an axial distance change.

In a further preferred method embodiment, the change includes a modification of the workpiece axis-related axial position of the tooth end edge of the toothing system. The workpiece axis-related axial position of the tooth end edge usually indeed plays a subordinate role in the production of the toothing system, but not in chamfering processes or when producing points, in which the type of workpiece clamping as described in more detail below is changed for improved accessibility.

According to a preferred embodiment, a clamping for the second machining operation is set such that the end faces of the toothing system produced in the first machining operation are accessible to the chamfering tool and are not obstructed due to clamping-related reasons.

In a further preferred method embodiment, the change includes a radial adjustment of the tool of the first machining operation / of the axial distance of the axes of rotation of the first machining operation. The detection of the change on the part of the controller can thus preferably take place on the level of the machine axis settings themselves, but also (see above) at the level of the properties, such as the flank line profile and/or tooth thickness, that can be determined directly on the workpiece.

In a further preferred method embodiment, the change includes a pivot angle of the tool of the first toothing system and/or a superposition of machine axes of the first machining operation, e.g., tangential axis (Y) or axial axis (Z), and possibly additional rotations (ΔC, ΔB), resulting in a flank modification. A pivot angle change, if carried out, usually occurs during hobbing or skiving; depending upon the implementation of the machine axes of the first machining operation, machining point displacements can also be taken into account by changing a tangential axis and additional rotations.

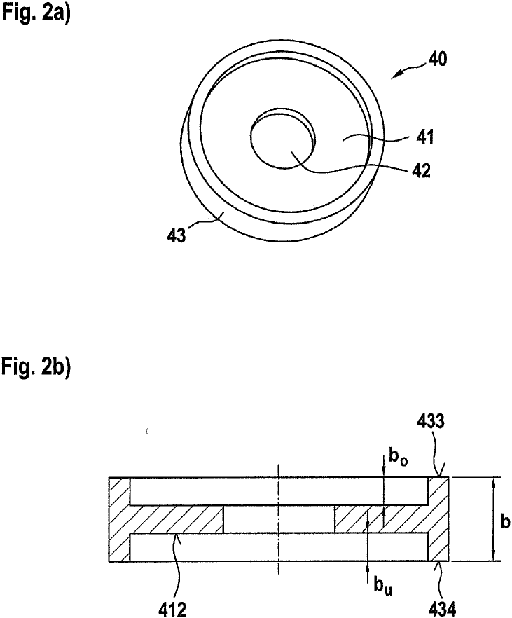

In a further preferred method embodiment, it is provided that, prior to the second machining operation, a measurement be carried out on the workpiece with regard to a change influencing the clamping height, the result of which the controller accesses. In particular, if the workpiece blanks are delivered in larger tolerance zones or if, with regard to deviations arising when the workpieces are turned out, there is a deviation that is not relevant to the first machining operation itself, deviations even within the tolerance zones can lead to displacements of the clamping height for the second machining operation, which, when combined with deviations within the tolerance zones of the first machining operation, can lead to deviations of the machining results of the second machining operation outside the tolerance zones. In a preferred method embodiment, during a measurement, the clamping height of one or both of the transverse planes of the toothing system produced in the first machining operation is monitored during the clamping for the second machining operation, and the controller in particular automatically obtains access to the actual clamping height or deviation of the workpiece from the target clamping height. By way of example, the axial distance of a known position of the sensor plane from the plane of the top plane area of the toothing system (chamfering plane) is determined by a sensor. The determination of a measured variable that determines the deviation from the target clamping height (e.g., bᵤ; see FIGS. 2a 2b below) can already take place before the clamping for the second machining operation. Preferably, it takes place in parallel to the main time of the first machining operation, e.g., during workpiece automation of moving the workpieces to the first machining operation. When the workpieces are tracked, the measured variable can be stored assigned to the workpiece in the controller.

In a further preferred method embodiment, it is provided that, prior to the second machining operation of a workpiece, no check of the machining result of the second machining operation take place on the previous workpiece or on one of the last n previous workpieces, where n is preferably at least 5 - in particular, at least 10. The previously explained change in the clamping height is independent of the machining result of the first machining operation, whereas, even in the method according to the invention, a random check of the overall machining result can be carried out. However, according to the invention, as a result of the detection of the changes, it is not necessary to continuously monitor the overall result.

In a further preferred method embodiment, during the detection, at least one change is determined from changed machine axis settings of the first machining operating, without resorting to a specific measurement on the workpiece. In this context, due to the detected changes, changes in the relative positioning can be carried out at least for a proportion of in particular more than 30%, and preferably more than 50%, of the machined workpieces of the series, the detection of which does not trace back to a detected specific measurement on the workpiece - in particular, to the machining result of the first machining operation.

In a further preferred method embodiment, the controller is designed for a basic setting for performing the second machining operation in accordance with an input of parameters of the target geometry and of the machining tool, as well as, if applicable, clamping parameters. The operator is thus still able to input the desired chamfer parameters in advance for the second machining operation.

In a preferred method embodiment, when a change is detected, the control parameters of the basic setting, and not the input parameters, are changed. In principle, the machine controller would be able to calculate the changes programmed by the experienced operator in the conventional prior art and to make them available to the operator for input. However, this is not necessary; the input parameters in this regard can remain at the target value, and the change in the relative positioning is aimed at maintaining the target parameters as input by responding to the detected changes at least partially – in particular, fully –automatically. Accordingly, the at least partially automatic detection of the change in the workpiece property and/or of the factors of the first machining operation, compared to a respectively predetermined reference, is preferably a fully automatic detection.

In a further preferred embodiment, the at least partially automatic detection comprises semi-automatic applications to the extent that a machine operator is prompted by the machine controller to display a change detected by the machine controller and a relative re-positioning calculated therefrom, wherein the machine operator can confirm or discard the re-positioning.

This is explained using the following scenario: If the machine operator carries out a correction on the basis of the produced and measured inclination angle for the first machining operation in a correction dialog of the machine, the chamfering is to be set to this toothing system already produced by correction during the first machining operation, e.g., the hobbing, and the machine operator will confirm the corresponding re-positioning. The same applies to corrections, e.g., of the fine-tuning, that are set during the first machining operation after the measurement of further workpieces, or a targeted correction after a small number of machining pieces in the de facto new tool condition.

If, after a higher number of pieces, tool wear occurs, which would lead to an unnoticed change in the inclination angle produced, and if a correction in this regard for the first machining operation ensures only a counteraction for wear compensation, which re-establishes the inclination angle profile expected from the second machining operation, the current relative positioning used for the second machining fits here, and the machine operator will accordingly discard the possible re-positioning displayed to the machine operator as a consequence of the automatic machining.

In a particularly preferred embodiment, in the case of an implemented clamping height monitoring, a re-positioning due to a change in this respect is carried out fully automatically, whereas, in any case, after the process setup has been completed for a batch of a series production, the machine controller, which responds to a change in the settings of the first machining operation, operates semi-automatically with regard to carrying out the re-positioning in this respect.

The invention also relates to a control program, which, when executed on a toothing machine, controls the machine for carrying out a method according to one of the aforementioned aspects, and to a toothing machine which is controlled to carry out the method.

In the case of this toothing machine, the second machining operation can take place on the toothing machine itself, at a machining station assigned thereto or via a machining station automatically coupled thereto, but also on a completely separate machine. Nevertheless, for coupling the controllers of the first machining operation as well as the controller for the second machining operation, it is ensured that the factors of the first machining operation, compared to the respective reference, are detected and can be accessed by the controller of the second machining operation.

In a preferred embodiment, the machining unit carrying out the second machining operation has means for the sensor-based detection of the tooth space center and/or of the clamping height of the transverse plane, in which the tooth edges to be chamfered are located (in the case of the end faces of the toothing system that are not orthogonal to the axis of rotation of the teeth, the clamping height of the axial position of the tooth tips can, for example, be used as a reference on the workpiece for the clamping height).

The information required for the clamping height can, for example, be derived via the axial distance of an end face of the toothing system from the plane of the sensor.

In the following, the invention is further described with reference to embodiments which are explained with reference to the attached figures, of which

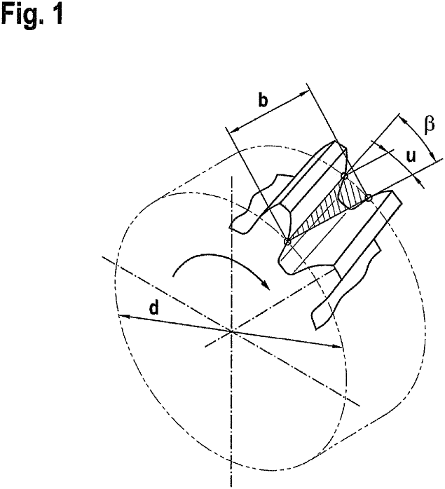

FIG. 1 is a view for illustrating parameters of the process design,

FIGS. 2a, 2b shows representations of a workpiece blank,

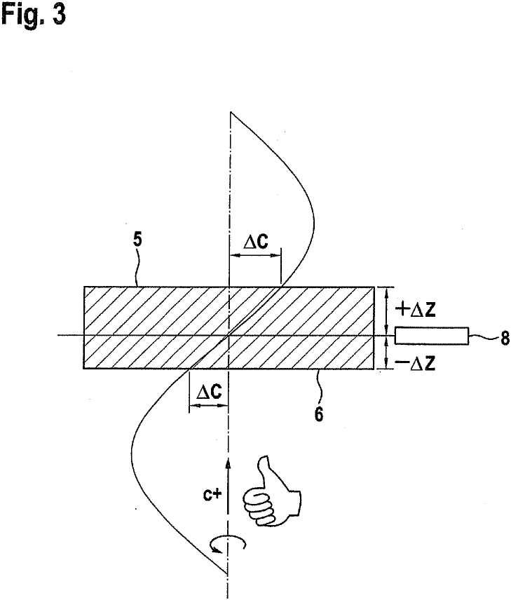

FIG. 3 shows a schematic illustration of an additional rotation in the case of an axial displacement of a toothing system,

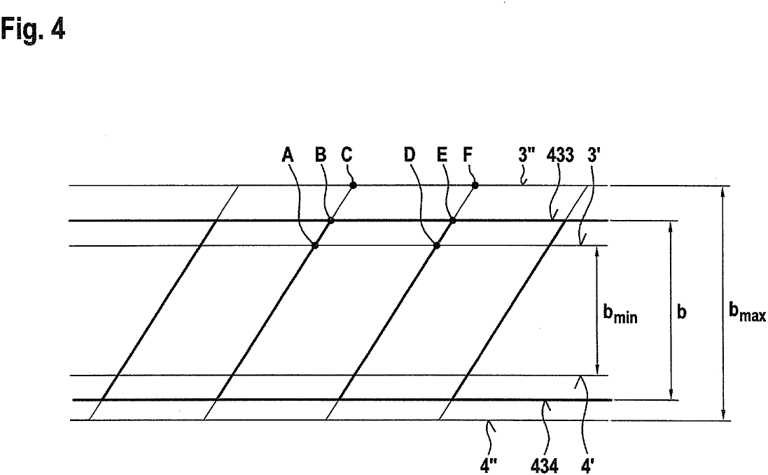

FIG. 4 is a schematic representation of the tooth edge position at different end edge heights,

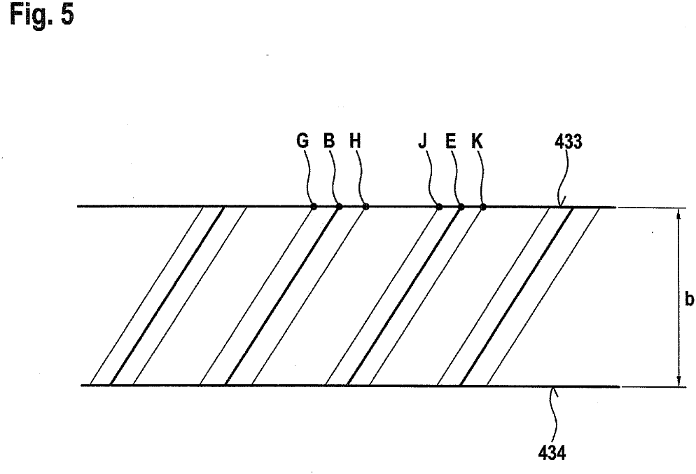

FIG. 5 shows a representation of the tooth edge position at different tooth thicknesses,

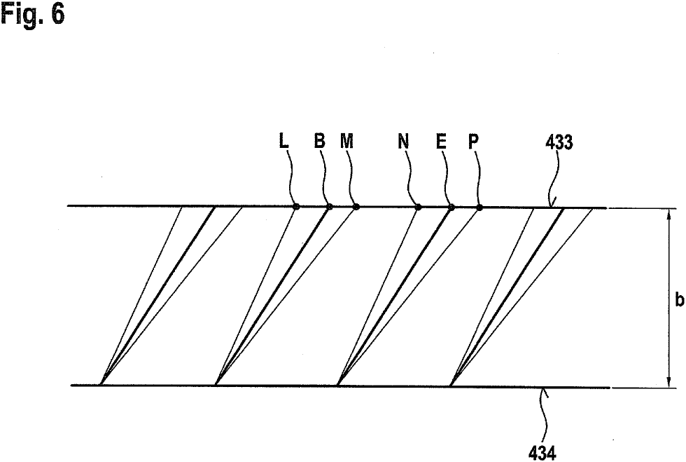

FIG. 6 is a schematic representation of the tooth edge position in the case of a flank line modification,

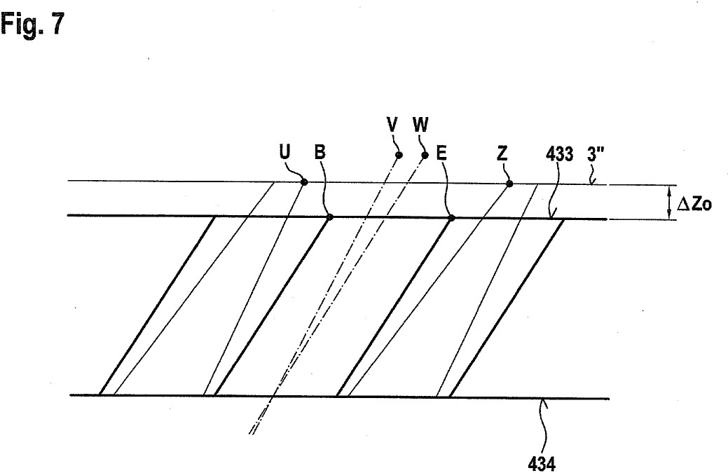

FIG. 7 is a schematic representation of the position of the tooth edges when several influences are superposed.

First, with reference to FIG. 1, some parameters underlying the process design are described using the example of a cylindrical helical toothing system. The process design is basically based upon a gear wheel or a toothing system in which all dimensions are to be exactly the nominal dimension. Considered parameters usually include the number of teeth z₂, the normal module mₙ, the normal intervention angle αₙ, the inclination angle β at the pitch circle, the profile displacement xm, the tip circle diameter da₂, the root circle diameter df₂, and the tooth width b. In FIG. 1, the diameter at the pitch circle is denoted by d, the inclination angle β relates to the tooth flank, which is further displaced on the pitch circle cylinder as a result of the helical toothing relative to a parallel to the axis of rotation, and the latter is denoted by u in FIG. 1.

With reference to FIGS. 2a 2b, a typical blank 40 is first shown in FIG. 2a in a perspectival view. In various applications, this blank can have an annular cylindrical outer region 43, from which the subsequent toothing system is produced, as well as a disk-shaped body 41 which is penetrated by a through-bore 42 and is located in a plane orthogonal to the axis of rotation of the toothing system. The outer ends (as viewed in the axial direction) in the form of an upper end face 433 and a lower end face 434 of the outer annular body 43 extending axially over the gear width b can be spaced apart from the end faces of the inner annular body 41. In FIG. 2b, this distance is denoted by bₒ (width of turned recess at the top) and bᵤ (width of turned recess at the bottom). When hobbing a toothing system from the workpiece blank 40, the blank rests on the outer annular body 43, and more precisely on the lower end face 434, for example. During chamfering carried out, for example, with a separate clamping, the workpiece is, on the other hand, mounted via the lower end face 412 of the inner disk body 41 if the tooth end edges are to be chamfered on both end faces of the workpiece toothing system without intermediate clamping change.

It can also be seen from FIG. 2b that manufacturing-related deviations via changes in bₒ and/or bᵤ when the blank is turned out can result in a fluctuation of the position of the faces 434 and 433 compared to the face 412.

While such a manufacturing tolerance in the case of hobbing of the toothing system is usually irrelevant even with support on the end face 434, since the axial machining path during hobbing is set to the maximum tooth width in any case, the situation is different when clamping with support on the end face 412. This is because the planes of the upper and lower end faces 433 and 434 are located at a relative position that is different depending upon the manufacturing tolerances during the turning-out, compared to the direct support on which the support face 412 rests. Usually, the reference position is not the direct support for the support face 412, but, rather, a machine reference, e.g., the height of the machine table, which includes clamping means. Compared to the “clamping height” h defined on the machine side, there is thus possibly a deviation in the axial position of the planes of the upper and lower end faces 433, 434 relative to the target position. It goes without saying that the word selection, “height,” refers to extensions in the direction of rotation of the workpiece, and not only vertical machines, but also horizontal machines or machines in oblique axis positions can be used.

When the tooth edges of a toothing system are chamfered, the position of the teeth relative to the table axis is first determined with a sensor, and the tooth edges to be machined in the upper and lower end faces 433, 434 are thus also determined. With knowledge of the axial distance of the upper end face of the toothing system, e.g., to the plane of the sensor, the toothing system can be positioned, e.g., via the machine table axis, in such a way that, when viewed axially, the tooth edges on the upper end face 433 can be rotated into the desired position, and likewise for chamfering on the lower end face 434.

While it would be sufficient in the case of straight toothing systems to set the for setting the planes of the upper or lower end faces 433, 434 to the desired machining position via a mere axial movement, the workpiece must additionally be rotated in the case of a helical toothing system, in order to hold the tooth space at the desired chamfer height in the machine center.

In the case of an axial correction ΔZ, this results in a required additional rotation of ΔC = ΔZ x 360°/pz, where pz is the pitch height of the helical toothing system (the tooth space follows a helical line with pitch height), and is given by z x mₙ x Π/sin | β |. When the table is rotated in the clockwise direction, ΔC has the same sign as that of the axial displacement in the case of a right-inclined β and has the reverse sign in the case of a left-inclined β. The reverse sign rule applies when the table is rotated counter-clockwise (rotation about workpiece axis C).

This additional rotation with axial displacement is shown again schematically in FIG. 3, with position sensor 8, and machining planes 5, 6, in which the tooth edges are located.

With regard to the relative position of the chamfering tool to the planes of the end faces 433 and 434, it is possible to use, for example, a quadruple of pivot angle η, axial distance ΔX, distance to machine center ΔY, distance to the chamfering plane ΔZ, i.e., for the plane of upper end face 433 (η₃, ΔX₃, ΔY₃, ΔZ_{3′}), and accordingly at the lower plane of the end face 434 (η₄, ΔX₄, ΔY₄, ΔZ₄).

With regard to the absolute machine position of the chamfering tool, the values of the relative position can be used for the pivot angle, the axial distance, and the distance to the machine center, whereas, with regard to the distance to the chamfering plane, axial values of Z₃ = h - bᵤ + b + ΔZ₃ for the upper plane and Z₄ = h - bᵤ - ΔZ₄ must be taken into account in addition to the rotations C₃ or ΔC₄.

FIG. 4 shows the situation of the position of the tooth edges at different heights of the end edges again. The nominal dimension of the gear width b is between a minimum gear width bₘᵢₙ and a maximum gear width bmax. The position of the sharp edge of the left flank at the nominal tooth width is denoted by B, and that of the blunt edge of the right flank is denoted by E. For deviations from higher toothing width (bmax), these positions are denoted by C or F, and, for smaller toothing widths, by A and D. It can thus be seen how manufacturing-related deviations when the blank is turned out can lead to different positions of the tooth edges at the resulting different heights of the end edges, i.e., position changes can be taken into account during a subsequent machining (second machining), e.g., chamfering, which changes are independent of the preceding toothing system production itself, and can thus occur even if the machining of the toothing system were to take place ideally at 100% on nominal dimension production.

However, a change in position of the tooth edges can also result in the case of changes, e.g., of the tooth thickness, resulting from the toothing production. This is illustrated in FIG. 5, in which B and E denote the position of the sharp edge of the left flank and blunt edge of the right flank, respectively, at nominal tooth thickness, which are displaced in the case of thinner teeth in the plane orthogonal to the workpiece axis of rotation to G, K in thinner teeth, or H, J in thicker teeth.

As another example, FIG. 6 shows a change in the position of the tooth edges in the case of a flank line modification f_{Hβ} arisen during the toothing production. As can be seen in this regard from FIG. 6, the position of the nominal positions B, E changes to L, N in the case of a modification β-, and to a position M, P in the case of a modification β+. If only the crowning (symmetrical edge line modification c_{β}) changes, the position of the nominal positions B, E does not change.

The case of a superposition of several influences of the variants illustrated using FIGS. 4, 5, and 6 is shown in FIG. 7.

Again, b denotes the sharp edge of the left flank in the nominal position, and E denotes the blunt edge of the right flank in the nominal position, with associated profile W of the tooth space center at inclination angle β in the nominal dimension. In contrast, the profile V of the resulting tooth space center with inclination angle β correlates with the position of the resulting position U of the acute position of the left flank and the resulting position Z of the blunt edge of the right flank, wherein the axial distance between the upper end face 433 according to the nominal dimension and the upper end face 3″ at the height of U, Z is denoted by ΔZₒ.

Compared to the nominal values, the axial distance and the inclination angle change for the example of the hobbing when toothing corrections are produced; thus, a tooth thickness correction leads to a constant axial distance change ΔX₁, whereas a flank line angle correction likewise has a contribution ΔX₂ (Z) to the axial distance change, which is dependent upon the axial position Z, and additionally an inclination angle change Δβ.

In contrast, the following changing values must be taken into account during chamfering: The inclination angle change leads to a pitch height change Δpz, the pitch height change, as explained above, leads to an additional rotation ΔC_{pz}, the height difference of the upper end faces 433 and 3″ of FIG. 7, Δzₒ and the additional rotation ΔC₀ associated with the transition from end face 433 to end face 3″.

The relative positioning as a function of the detected change thus takes place to an end position of an absolute machine position of the chamfering tool from plane 433 to 3″, to the effect that the same pivot angle is assumed (η3” = η₃). For the axial distance, X_{3”} = ΔX₃ + ΔX₁ + ΔX₂ (Z) is set, the distance to the machine center can be left as is, the distance to the chamfering plane is set to Z₃ = h - bᵤ + b + ΔZ₃ + ΔZ₀, and ΔC₃ + ΔC_{pz} + ΔC₀ results for the rotation. The index “3” here stands for the face 433.

As already explained above, the last-mentioned contributions ΔC serve the goal of rotating the workpiece tooth space at the height of the chamfering plane by workpiece rotation into the machine center, and are composed of the rotation from the sensor plane to the original plane 3, ΔC₃, an additional rotation ΔC_{pz} in the case of any inclination angle change, and the additional rotation ΔC₀, which accounts for the transition from plane 433 to plane 3″.

The above explanations relate predominantly to the upper face 433; a corresponding procedure is used for the lower face 434.

It goes without saying that deviations from exact calculations are possible, and that approximations, estimates, and/or rougher corrections, e.g., according to correction tables, can also be used, and that the above representation represents only one possible type of implementation.

For the implementation of the relative position, it is possible with respect to individual axes to reposition – instead of the machine axis of the chamfering tool – the workpiece-side machine axes, which lead to the same relative positioning as the determined absolute positioning of the chamfering tool.

Similar to the toothing production of the first machining operation by means of hobbing, skiving, or generating shaping could also be used, and the changes of the first machining operation leading to the axial distance change and/or inclination angle change could be used as the basis.

In this respect, the invention is not limited to the method described in the exemplary embodiments. Rather, the features of the following claims as well as of the above description, or in combination, can be essential for the realization of the invention in its various embodiments.

1. Method for machining toothing systems, in which, for a series of workpieces with an identical target geometry, a toothing system is produced or machined on a respective workpiece having an axis of rotation in a first machining operation by a first machining tool having an axis of rotation and, in a second machining operation, with a second machining tool having an axis of rotation, additional tooth shaping of the toothing system resulting from the first machining is carried out in a relative positioning with respect thereto,
characterized in that a controller of the second machining operation automatically detects, at least in part, a change in a workpiece property, which is independent of the first machining operation, and/or in a setting of the first machining operation and carries out the relative positioning as a function of the detected change.

2. Method according to claim 1, in which the first machining operation is a soft machining operation shaping.

3. Method according to claim 1 in which the second machining operation is a cutting chamfering, and the target geometry has in this respect a predetermined chamfer shape and chamfer size.

4. Method according to claim 1 in which the second machining is carried out in a rolling method .

5. Method according to claim 1 in which the change includes a modification of the flank line of the toothing system.

6. Method according claim 1 in which the change includes a modification of the tooth thickness of the toothing system.

7. Method according to claim 1 in which the change includes a modification of the workpiece axis-related axial position of the tooth end edge of the toothing system.

8. Method according to claim 1 in which the change includes a radial adjustment of the tool of the first machining operation and/or an adjustment of the axial distance of the workpiece and tool axes of rotation of the first machining operation.

9. Method according to claim 1 in which the change includes a pivot angle of the tool of the first toothing system and/or a superposition of machine axes of the first machining operation including tangential axis (Y) or axial axis (Z), and/or additional rotations (ΔC, ΔB), resulting in a flank modification.

10. Method according to claim 1 in which, prior to the second machining operation, a measurement is carried out on the workpiece, the result of which the controller accesses.

11. Method according to claim 1 in which, prior to the second machining operation of a workpiece, no check of the machining result of the second machining operation takes place on the previous workpiece or on one of the last n previous workpieces, where n is preferably at least 5 .

12. Method according to claim 8 in which, during the detection, at least one change is determined from changed machine axis settings of the first machining operating, without resorting to a specific measurement on the workpiece.

13. Method according to claim 1 in which the controller of the second machining operation is designed for a basic setting for performing the second machining operation in accordance with an input of parameters of the target geometry and of the machining tool if including any applicable clamping parameters.

14. Method according to claim 13, in which, when a change is detected, the control parameters of the basic setting, and not the input parameters, are changed.

15. Control program which, when executed on a controller of a toothing machine, controls the machine to carry out a method according to claim 1.

16. Toothing machine for carrying out a first machining operation for producing a toothing system on a workpiece and for carrying out an additional tooth shaping by a second machining operation on the workpiece, characterized in that the toothing machine has a controller designed to carry out a method according to claim 1.

17. Method according to claim 1 wherein the second machining operation comprises chamfering of a tooth end edge of the toothing system.

18. Method according to claim 1 wherein the setting of the first machining operation comprises a predetermined reference with respect to the first machining operation.

19. Method according to claim 2 wherein the soft machining operation comprises hobbing, skiving, or generating shaping.

20. Method according to claim 4 wherein the rolling method comprises the kinematics of hobbing.
